(19) United States
(12) Patent Application Publication
(10) Pub. No.: US 2020/0215418 A1
(43) Pub. Date: Jul. 9, 2020

(54) DISC SYSTEM WITH DISC FOR TUNING SKI AND SNOWBOARD EDGES

(71) Applicant: Richard Weissenborn, Calgary (CA)

(72) Inventor: Richard Weissenborn, Calgary (CA)

(21) Appl. No.: 16/748,650

(22) Filed: Jan. 21, 2020

Related U.S. Application Data
(63) Continuation-in-part of application No. 15/677,541, filed on Aug. 15, 2017.

(51) Int. Cl. A63C 11/06; B24B 3/00

(52) U.S. Cl. CPC A63C 11/06; B23D 67/12; B24B 3/006

(57) ABSTRACT

A disc system including disc adapted to be held by the hand and moved lengthwise along an edge portion of a ski or snowboard in order to sharpen and/or bevel either a ski or a snowboard side edge or base edge is provided. The disc is held and may be rotated within at least one concentric ring to establish a number of selected angular orientations in a plane transverse to the lengthwise direction when positioned at the side or base edge portion of the ski or snowboard while in contact with the surface thereof.

### FIELD OF DISCLOSURE

The present disclosure relates to an apparatus for tuning an edge of snow sports equipment, such as a side or base edge of a ski or snowboard.

### BACKGROUND

Prior art edge sharpening apparatus for skis and snowboards typically include a guide adapted to be handheld by a technician and moved lengthwise along an edge portion of a ski or snowboard while in contact with the surface thereof. Such apparatus may also include a clamping mechanism for clamping a file or the like (e.g. commercially available cutting and polishing implements such as mill files, diamond stones etc.) in or to the guide.

Past ski and snowboard designs incorporated metal edges with conventional 90° (degree) edge geometry (ski or snowboard base edge and base create a flat running surface with the side edge perpendicular to the base edge). More recent ski and snowboard designs have changed dramatically as a result of technological advances in materials and construction. These more recent ski and snowboard have side cuts and cambers that are more pronounced than earlier designs. While the base of the current designs has remained relatively flat, current skis and snowboards are manufactured having inherent base edge and side edge bevel angles. As a result, prior art sharpening apparatus have issues in maintaining at least one or both of base edge and side edge bevel angles when sharpening (and polishing) a ski or snowboard, which is a characteristic of optimal ski and snowboard performance.

### SUMMARY OF THE DISCLOSURE

In a first aspect, an apparatus for supporting a sharpening disc when tuning the base edge of a ski or snowboard is provided. The apparatus comprises: a first tool support ring having an outer surface, an inner surface and a first disc support surface connecting the outer surface to the inner surface, the first disc support surface providing a surface to orient the sharpening disc at a set elevation and angle relative to the base edge when the sharpening disc is placed upon the base edge.

In the apparatus, the first tool support ring may further comprise a second tool support surface connecting the outer surface to the inner surface in a space relationship to the first tool support surface, the second tool support surface providing a second surface for placing the sharpening disc when sharpening the base edge.

In the apparatus, the first tool support ring may further comprise a third tool support surface connecting the outer surface to the inner surface in a space relationship to the first and second tool support surfaces, the third tool support surface providing a third surface for placing the sharpening disc when sharpening the base edge.

In the apparatus, the first tool support ring may further comprise a fourth tool support surface connecting the outer surface to the inner surface in a space relationship to the first, second and third tool support surfaces, the fourth tool support surface providing a fourth surface for placing the sharpening disc when sharpening the base edge.

In the apparatus, the first and second tool support surfaces may be symmetric to each other about a longitudinal axis of the first tool support ring. Also, the first and second tool support surfaces may be asymmetric or parallel to each other.

In the apparatus, the first and second tool support surfaces may taper towards each other from the outer surface to the inner surface.

In the apparatus, the third and fourth tool support surfaces may be symmetric to each other about a longitudinal axis of the first tool support ring. Also, the third and fourth tool support surfaces may be asymmetric or parallel to each other.

In the apparatus, the third and fourth tool support surfaces may taper towards each other from the outer surface to the inner surface.

In the apparatus, the sharpening disc may be inserted within the first tool support ring in a plurality of complementary positions at one of a plurality of angular orientations to orient the sharpening tool at a plurality of edge angles to the edge when the apparatus is positioned at a base edge portion of the ski or snowboard.

In another aspect, an apparatus for sharpening and/or beveling of a ski or snowboard side wall and/or side edge including a guide for placing an abrasive disc is provided. The apparatus comprises: a first tool support ring connected to a second tool support ring of a similar diameter such that the centers of both rings share a common point and their planes are approximately perpendicular to each other; the second tool support ring having an outer surface, an inner surface and a fifth disc support surface connecting the outer surface to the inner surface, the fifth disc support surface providing a surface to orient the sharpening disc at a set elevation and angle relative to the side edge when the sharpening disc is placed upon the side edge; the sharpening disc detachably matable to, and rotatable within the first tool support ring.

In the apparatus, the second tool support ring may further comprise a sixth tool support surface connecting the outer surface to the inner surface in a space relationship to the fifth tool support surface, the sixth tool support surface providing a sixth surface for placing the sharpening disc when sharpening the side edge.

In the apparatus, the second tool support ring may further comprise a seventh tool support surface connecting the outer surface to the inner surface in a space relationship to the fifth and sixth tool support surfaces, the seventh tool support surface providing a seventh surface for placing the sharpening disc when sharpening the side edge.

In the apparatus, the second tool support ring may further comprise an eighth tool support surface connecting the outer surface to the inner surface in a space relationship to the fifth, sixth and seventh tool support surfaces, the eighth tool support surface providing an eighth surface for placing the sharpening disc when sharpening the side edge.

In another aspect, an apparatus for the sharpening and/or beveling a ski or snowboard base edge is provided comprising a first tool support ring, at least one position indexing tab and a sharpening disc detachably mounted to, and rotatable within, the first tool support ring; the sharpening disc having at least one abrasive surface able to be placed in contact with the contact area on an edge of a ski and rotated as necessary by the hand to expose unused abrasive surface to the contact area in order to efficiently cut and polish the base edge.

The apparatus may further comprise a sharpening disc that may be detachably mounted to the first tool support ring creating angular orientations of the apparatus and the sharpening disc in a plane transverse to said lengthwise direction when the apparatus is positioned at the side edge portion of the ski or snowboard, thereby establishing a desired side wall and/or side edge geometry or bevel angle.

In another aspect, an apparatus for the sharpening and/or beveling of either a ski side edge or base edge is provided comprising a first tool support ring, a second tool support ring and a sharpening disc detachably mounted to, and rotatable within, the first tool support ring; the sharpening disc having at least one abrasive surface able to be placed in contact with the contact area on an edge of a ski and rotated as necessary by the hand to expose unused abrasive surface to the contact area in order to efficiently cut and polish the side wall, side edge or base edge.

According to one embodiment, the first tool support ring has a first recess, a second recess, a third recess and a fourth recess, each tool support surface being stepped inwards towards the middle of the first tool support ring providing a gap between the contact area on a base edge of a ski and the first tool support ring allowing the sharpening disc to contact the contact surface of the base edge without interference from first tool support ring, and to prevent any burrs along the edge from coming in contact with and cutting, grinding or otherwise causing damage to the first tool support ring.

According to one embodiment, the second tool support ring has a first recess, a second recess, a third recess and a fourth recess, each tool support surface being stepped inwards towards the middle of the second tool support ring providing a gap between the contact area on a base edge of a ski and the second tool support ring through which edge filings and debris may fall between the second tool support ring and base of the ski when the sharpening disc is in contact with the side edge, or side wall and the apparatus is moved along an edge portion of the ski while in contact with a surface thereof.

The apparatus may further comprise a sharpening disc mounted within a first tool support ring having at least one position indexing tab along its circumference, each position indexing tab providing an alignment feature for the sharpening disc marking a contact area for an abrasive or file surface on an edge of the ski or snowboard and acting to index the first tool support ring and sharpening disc relative to the edge surface when the apparatus is moved lengthwise along the side edge portion of the ski or snowboard while in contact with a surface thereof.

In the apparatus, the second tool support ring may comprise at least one open area inside its inner surface through which fillings created when tuning an edge of the ski or snowboard may fall to prevent the filings from becoming lodged between a second tool support ring support surface and scratching either the side or base of a ski or snowboard when apparatus is moved lengthwise along an edge portion of the ski or snowboard while in contact with a surface thereof.

In the apparatus, the second tool support ring may have at least one threaded aperture in approximately its middle section to facilitate holding a file within a sharpening disc file indent by turning a set screw (or other similar fastener) through the aperture until it comes in contact with the file.

In the apparatus, the shape of the sharpening disc may be circular; and the position indexing tab indicates that approximately half of the sharpening disc will contact the contact area.

The apparatus may further comprise: a sharpening disc having an abrasive disc indent on one or both sides to indicate an alignment of an abrasive disc (when placed on a surface of the sharpening disc prior to being adhered), and once adhered prevent unwanted movement of the abrasive disc relative to the sharpening disc when the apparatus is moved lengthwise along an edge portion of the ski or snowboard while in contact with a surface thereof.

The apparatus may further comprise: a sharpening disc having a file indent to receive and position a file within the sharpening disc and prevent unwanted movement of the file relative to the sharpening disc when the apparatus is moved lengthwise along an edge portion of the ski or snowboard while in contact with a surface thereof.

According to another aspect, the sharpening disc is able to be detached from the first tool support ring, rotated 180° about its longitudinal axis and re-attached to the first tool support ring in order to change the abrasive surface or file contacting the contact surface an edge of the ski or snowboard.

In one aspect of an embodiment, a first tool support ring is matable with a sharpening disc via a set of mating features provided on an inner surface of the first tool support ring and outer surface of the sharpening disc that are being fit together. The mating features may interact with each other to provide a positive locking attachment between the first tool support ring and sharpening disc.

In the apparatus and according to one embodiment, the inner surface of the first tool support ring may be circular and shaped to mate with and retain an outer circular surface of a sharpening disc providing a bearing surface and allowing rotation of the sharpening disc around its vertical axis within the first tool support ring, the vertical axis of the sharpening disc being approximately 90° (ninety degrees) perpendicular to the longitudinal plane of the sharpening disc.

In the apparatus, the sharpening disc may be removable and interchangeable.

This apparatus is portable, inexpensive, easy to use and helps to minimize the fatigue and effort required to perform an accurate and consistent edge sharpening and beveling job, especially on ski and snowboard equipment with inherent base edge and side edge bevel angles as described above, and more fully described hereafter.

### BRIEF DESCRIPTION OF THE DRAWINGS

Embodiments of the disclosure will now be described, by way of example only, with reference to the accompanying drawings, in which:

FIG. 1 is a perspective view illustrating an apparatus of an embodiment with a first tool support ring connected to a second tool support ring and a sharpening disc positioned for the sharpening and/ or beveling of a side edge portion of a representative ski;

FIG. 2 is a perspective view illustrating the apparatus of FIG. 1 with a set screw clamping a file against a sharpening disc of an embodiment;

FIG. 3 is a perspective view illustrating the apparatus of FIG. 1 with a sharpening disc for tuning a representative ski base edge;

FIG. 4 is a perspective view illustrating the apparatus of an embodiment with a first tool support ring and sharpening disc for tuning a representative ski base edge;

FIG. 5 is a perspective view illustrating the first tool support ring of FIG. 4;

FIG. 6 is a perspective view illustrating the first tool support ring with sharpening disc of FIG. 4;

FIG. 7 is a perspective view illustrating the first tool support ring connected to the second tool support ring of FIG. 1;

FIG. 8 is a perspective view illustrating the first tool support ring connected to the second tool support ring with sharpening disc of FIG. 1;

FIG. 9 is a perspective view of the sharpening disc of FIG. 1;

FIG. 9A is a bottom view of the sharpening disc of FIG. 1;

FIG. 9B is a side elevation view of the sharpening disc of FIG. 1;

FIG. 9C is a top view of the sharpening disc of FIG. 1;

FIG. 10 is a perspective view of the sharpening disc with file indent of FIG. 2;

FIG. 10A is a bottom view of the sharpening disc with file indent of FIG. 2;

FIG. 10B is a side elevation view of the sharpening disc with file indent of FIG. 2;

FIG. 10C is a top view of the sharpening disc with file indent of FIG. 2;

FIG. 11 is a top view of the first tool support ring with sharpening disc of FIG. 6;

FIG. 11A is a cross section view of the apparatus along line A-A of FIG. 11;

FIG. 12 is a side elevation view illustrating the apparatus of FIG. 2 with a set screw clamping a file against a sharpening disc;

FIG. 12A is a cross section view of the apparatus along line A-A of FIG. 12;

FIGS. 13, 14, 15 and 16 are side views, with magnified views of the first tool support ring with sharpening disc of FIG. 4 resting on the base edge of a representative ski (shown in cross section) with the base edge surface perpendicular to a 90° side edge surface before the base edge is sharpened and/or beveled.

FIGS. 13A, 14A, 15A and 16A are side views, with magnified views of the first tool support ring with sharpening disc of FIG. 4 resting on the base edge of a representative ski (shown in cross section) after the base edge has been sharpened and/or beveled at approximately 0.5° (0.5 degree), 0.75°, 1.0° and 1.5° respectively;

FIGS. 17, 18, 19 and 20 are side views, with magnified views of the first tool support ring connected to the second tool support ring with sharpening disc of FIG. 3 resting on the base edge of a representative ski (shown in cross section) with the base edge surface perpendicular to a 90° side edge surface before the base edge is sharpened and/or beveled.

FIGS. 17A, 18A, 19A and 20A are side views, with magnified views of the first tool support ring connected to the second tool support ring with sharpening disc of FIG. 3 resting on the base edge of a representative ski (shown in cross section) after the base edge has been sharpened and/or beveled at approximately 0.5° (0.5 degree), 0.75°, 1.0° and 1.5° respectively;

FIGS. 21, 22 and 23 are side views, with magnified views of the first tool support ring connected to the second tool support ring with sharpening disc of FIG. 1 resting on the side edge of a representative ski (shown in cross section) with the side edge surface perpendicular to a 90° base edge surface before the side edge is sharpened and/or beveled.

FIGS. 21A, 22A and 23A are side views, with magnified views of the first tool support connected joined to the second tool support ring with sharpening disc of FIG. 1 resting on the side edge of a representative ski (shown in cross section) after the side edge has been sharpened and/or beveled at approximately 1.0° (1 degree), 2.0° and 3.0° respectively;

FIG. 24 is a side view, with a magnified view of the first tool support ring connected to the second tool support ring with sharpening disc of FIG. 1 resting on the side wall of a representative ski (shown in cross section) with the side wall surface perpendicular to a 90° base edge surface before the side wall is trimmed and/or beveled.

FIG. 24A is a side view, with a magnified view of the first tool support ring connected to the second tool support ring with sharpening disc of FIG. 1 resting on the side wall of a representative ski (shown in cross section) after the side wall has been trimmed and/or beveled at approximately 7.0° (7 degrees).

### DETAILED DESCRIPTION OF EMBODIMENTS

The description which follows and the embodiments described therein are provided by way of illustration of examples of particular embodiments of the principles of the present disclosure. These examples are provided for the purposes of explanation and not limitation of those principles and of the disclosure. In the description which follows, like parts are marked throughout the specification and the drawings with the same respective reference numerals.

Aspects of embodiments are described with respect to a sharpening tool being used in situ when sharpening or beveling an edge of a ski. The sharpening tool is typically a handheld file. The edge of the ski being sharpened is an edge that comes in contact with a snow surface. Typically one or both of a base edge and a side edge require sharpening. The term “edge”, when used herein for a ski or snowboard, will typically relate to an edge being sharpened, unless otherwise noted. Occasionally, the described edge may refer to an edge of a ski that is not being sharpened. However, the context of the term edge as used will be clear in view of the related text in the description. When an embodiment is described herein as being used to sharpen an edge of a ski, the ski can be an Alpine ski or Nordic ski, as suitably modified as needed. As well as sharpening an edge of a ski, an embodiment may be used to bevel an edge of a ski as well. The term “tuning” will be understood to describe sharpening and/or beveling an edge of a ski. As well, an embodiment may also be used to tune an edge of a snowboard. As such, it will be understood that for the purpose of this disclosure, the use of the term “ski”, represents a ski, a snowboard or both, unless otherwise noted. All these terms and contexts will be understood by those of relevant skill in the art.

To provide context for orientation and directional terms used herein, the term “longitudinal” used herein describes the direction along the major length of a ski (e.g. from front to back of the ski) and accordingly, the term “longitudinal”, when used herein in association with an embodiment describes a direction along the major length of the embodiment (e.g. from front to back of the embodiment when aligned with the front to back of a ski). Correspondingly, the term “transverse” used herein describes a direction across the major length of a ski (e.g. from left side to right side of the ski) and accordingly, the term “transverse”, when used in association with an embodiment describes a direction across the major length of the embodiment (e.g. from the left side to the right side of the embodiment when the embodiment is aligned with the front to back of a ski). The terms “longitudinal” and “transverse” and other orientation terms will have inherent and clear directional meaning in view of their context and related text in the description.

Briefly, an aspect of embodiment provides an apparatus that may be used to support a sharpening disc being used to tune an edge of a ski. In one aspect an apparatus has one or more rings within which the sharpening disc may be inserted. A ring, as in tool support ring, is shaped to provide one or more surfaces on which the disc can be supported as the apparatus is held against the ski while the edge is being tuned. The ring may be located on a contact surface of a ski in one or more positions, to present one or more of its surfaces to support the sharpening disc while the apparatus is in use with the ring being held by the hand against the base of the ski. Each surface may be shaped and/or angled to present a differently angled support base relative to the edge of the ski for the sharpening disc. As such, an apparatus has a ring that is a tool support ring that has one or more tool support surfaces.

In another aspect, an apparatus for sharpening and/or beveling of a ski base edge is provided having a sharpening disc held within a first tool support ring and adapted to be handheld and moved lengthwise along a base edge portion of a ski or snowboard while in contact with the surface thereof. The dimensions, and potential positions, locations and orientations, of the first tool support ring permit the sharpening disc to be oriented at a plurality of fixed positions relative to the ski base edge, to facilitate beveling of the ski base edge at one of a plurality of angles when the sharpening disc is held within the tool support ring at one of multiple predetermined fixed positions.

Another aspect provides an apparatus that may support a sharpening disc facilitating both base edge and side edge bevel angles when sharpening (and polishing) a ski. The apparatus has a frame comprising a first tool support ring connected to a second tool support ring of a similar diameter such that the centers of both rings share a common point and their planes are approximately perpendicular to each other; an inner surface of at least one of the tool support rings being circular and shaped to mate with and retain an outer circular surface of a sharpening disc providing a bearing surface between tool support ring and sharpening disc allowing the disc to be infinitely rotated around its vertical axis within one of the rings by the hand as necessary to expose unused abrasive surface, or to align the teeth of a file, along the contact area of an edge in order to efficiently sharpen (and polish) the side edge or base edge, the vertical axis of the sharpening disc being approximately 90° (ninety degrees) perpendicular to the longitudinal plane of the sharpening disc.

Yet another aspect provides a tool support ring used in conjunction with a sharpening disc, the apparatus used to bevel a base edge of a ski with at least one position indexing tab along its circumference, each position indexing tab providing an alignment feature for the sharpening disc marking a contact area for an abrasive or file surface on an edge of the ski and acting to index the first tool support ring and sharpening disc relative to the edge surface when the apparatus is moved lengthwise along the side edge portion of the ski or snowboard while in contact with a surface thereof allowing a technician using the apparatus to perform an efficient, accurate, and consistent edge sharpening and beveling job.

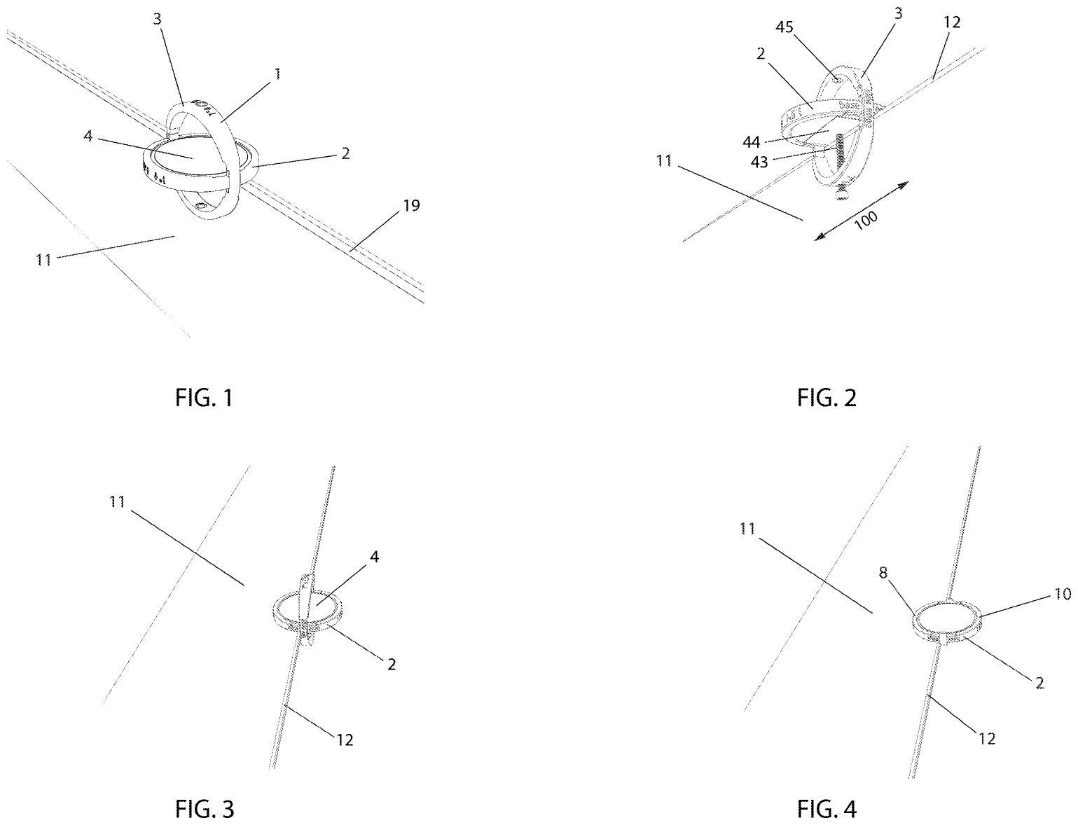

Referring firstly to FIG. 1, which illustrates one embodiment, there is shown an apparatus for tuning a ski side edge or base edge. For the sake of brevity, use of the term “ski” herein will be understood to include “ski or snowboard” and use of the term ski “edge” herein will be understood to include the skis's (or snowboard's “side edge” and/or “base edge”, unless otherwise noted. The apparatus comprises guide 1 adapted to be held by the hand of a technician and moved lengthwise along the base portion of a ski while in contact with the surface thereof. Further details of a holder configuration for guide 1 and its construction will be described below.

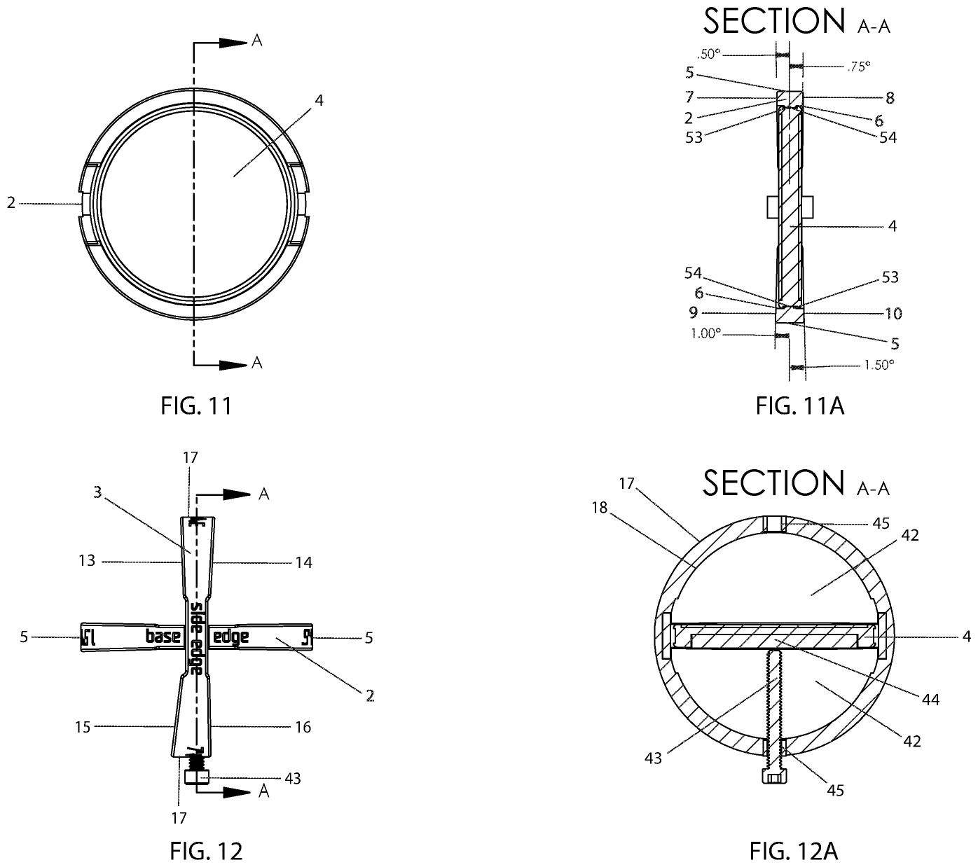

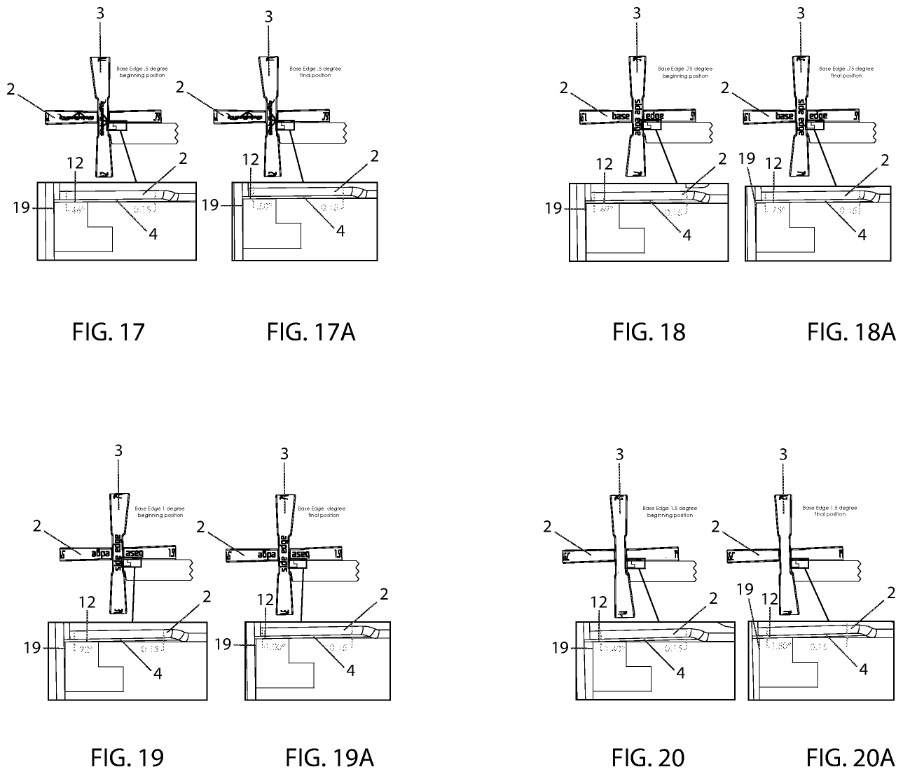

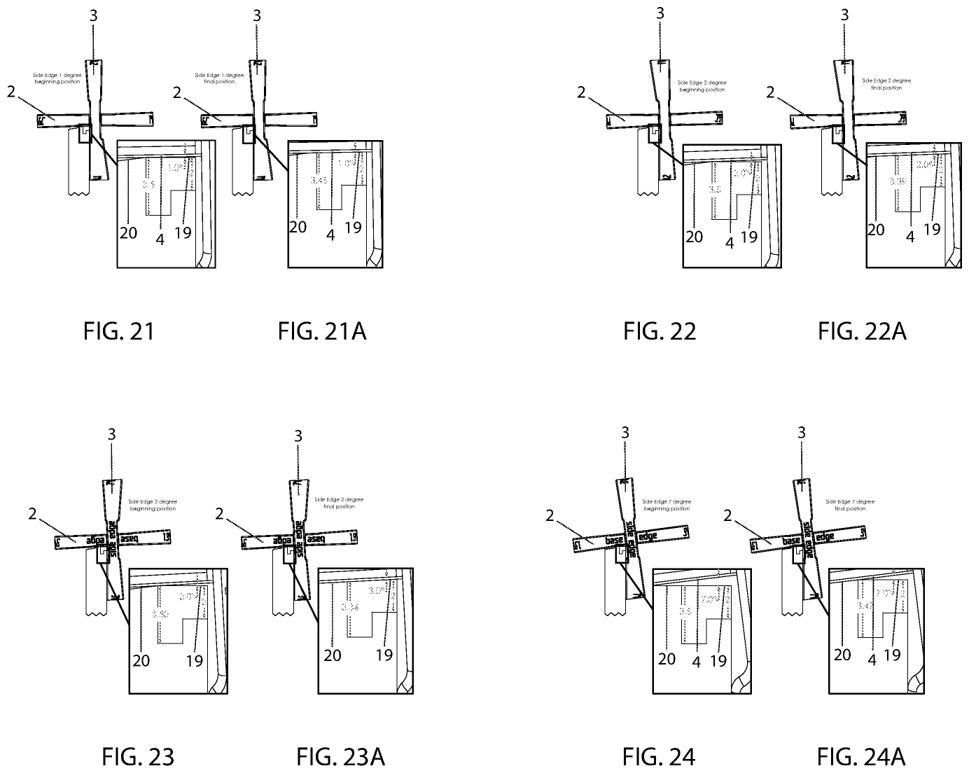

As shown in FIGS. 1, 2, 3, 7, 8, 12, 12A, 17, 17A, 18, 18A, 19, 19A, 20, 20A, 21, 21A, 22, 22A, 23, 23A, 24 and 24A in an embodiment, guide 1 comprises: a first tool support ring 2 connected to a second tool support ring 3 of a similar diameter such that the centers of both rings 2, 3 share a common point and their planes are approximately perpendicular to each other with a sharpening disc 4 inserted within the first tool support ring 2. As best shown in FIGS. 4 and 11A the first tool support ring 2 has a first tool support surface 7, a second tool support surface 8, a third tool support surface 9 and a fourth tool support surface 10 each connecting outer surface 5 to inner surface 6 with each disc support surface providing a surface to orient sharpening disc 4 at a set elevation and angle relative to ski base 11 in order to bevel and/or sharpen base edge 12. In the apparatus first tool support surface 7 and second tool support surface 8 may be symmetric to each other about a longitudinal axis of the first tool support ring 2. Also, first tool support surface 7 and second tool support surface 8 may be asymmetric or parallel to each other, or taper towards each other from outer surface 5 to inner surface 6 of first tool support ring 2. In the apparatus third tool support surface 9 and fourth tool support surface 10 may be symmetric to each other about a longitudinal axis of the first tool support ring 2. Also, third tool support surface 9 and fourth tool support surface 10 may be asymmetric or parallel to each other, or taper towards each other from outer surface 5 to inner surface 6 of first tool support ring 2.

As best shown in FIGS. 12, 12A, 21, 21A, 22, 22A, 23, 23A, 24 and 24A the second tool support ring 3 has a fifth tool support surface 13, a sixth tool support surface 14, a seventh tool support surface 15 and an eighth tool support surface 16 each connecting outer surface 17 to inner surface 18 with each disc support surface providing a surface to orient sharpening disc 4 at a set elevation and angle relative to ski base 11 in order to bevel and/or sharpen a ski side edge 19, or side wall 20. In the apparatus fifth tool support surface 13 and sixth tool support surface 14 may be symmetric to each other about a longitudinal axis of the second tool support ring 3. Also, fifth tool support surface 13 and sixth tool support surface 14 may be asymmetric or parallel to each other, or taper towards each other from outer surface 17 to inner surface 18 of second tool support ring 3. In the apparatus seventh tool support surface 15 and eighth tool support surface 16 may be symmetric to each other about a longitudinal axis of the second tool support ring 3. Also, seventh tool support surface 15 and eighth tool support surface 16 may be asymmetric or parallel to each other, or taper towards each other from outer surface 17 to inner surface 18 of second tool support ring 3.

In the apparatus, FIGS. 3, 17, 17A, 18, 18A, 19, 19A, 20 and 20A illustrate sharpening disc 4 that may be inserted within the first tool support ring 2 in a plurality of complementary positions at one of a plurality of angular orientations to orient the sharpening tool at a plurality of edge angles to the base edge 12 when the apparatus is positioned along a base portion of the ski.

For another embodiment FIGS. 1, 2, 21, 21A, 22, 22A, 23, 23A, 24 and 24A illustrate sharpening disc 4 that may be inserted within the first tool support ring 2 in a plurality of complementary positions at one of a plurality of angular orientations to orient the sharpening tool at a plurality of edge angles to the side edge 19, or side wall 20, when the apparatus is positioned and moved lengthwise (denoted by double arrow 100 in FIG. 2) along a side portion of the ski.

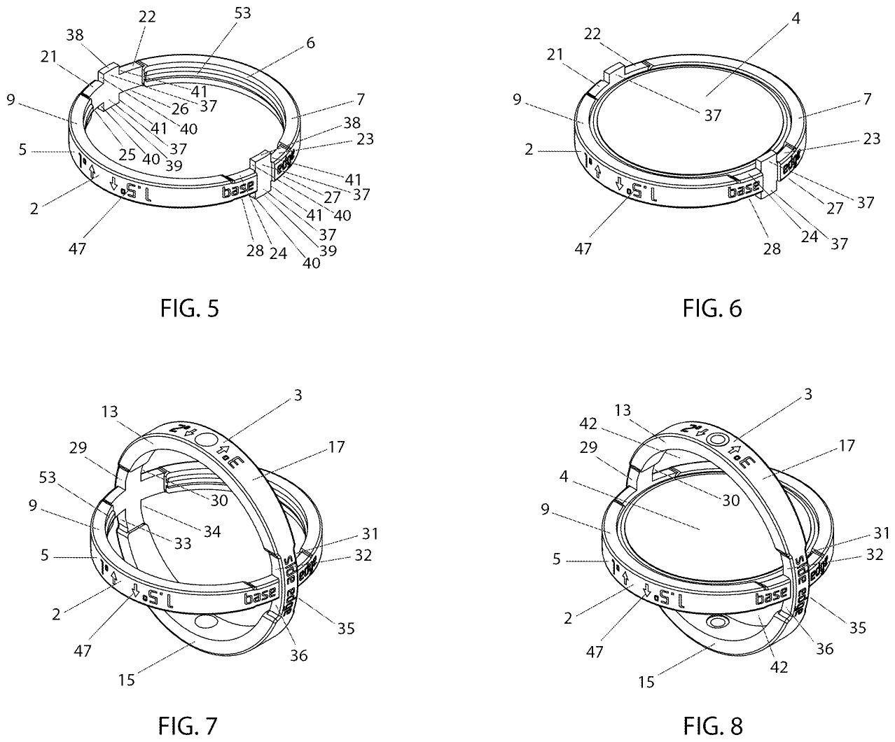

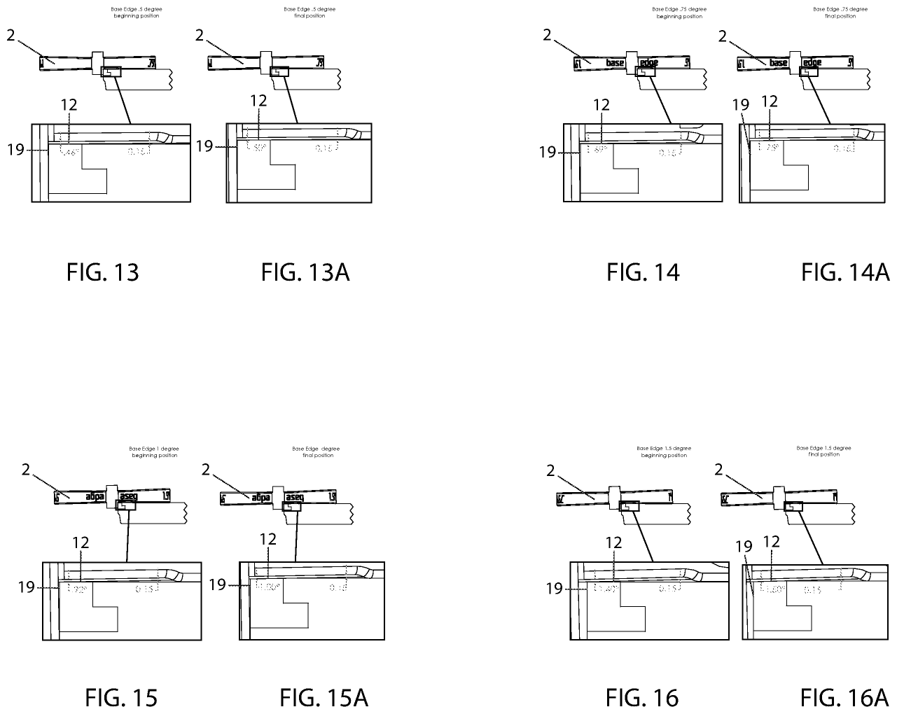

As best shown in FIGS. 5, 13, 13A, 14, 14A, 15, 15A, 16 and 16A and according to one embodiment, first tool support ring 2 has a first recess 21, a second recess 22, a third recess 23, a fourth recess 24, a fifth recess 25, a sixth recess 26, a seventh recess 27 and an eighth recess 28, each tool support surface being stepped inwards towards the middle of the first tool support ring 2 providing a gap between the contact area on a base edge 12 of a ski and the first tool support ring 2 allowing sharpening disc 4 to contact the contact surface of the base edge 12 without interference from first tool support ring 2, and to prevent any burrs along the edge from coming in contact with and cutting, grinding or otherwise causing damage to the first tool support ring 2.

As best shown in FIGS. 7, 21, 21A, 22, 22A, 23, 23A, 24 and 24A and according to one embodiment, second tool support ring 3 has a first recess 29, a second recess 30, a third recess 31, a fourth recess 32, a fifth recess 33, a sixth recess 34, a seventh recess 35 and an eighth recess 36, each tool support surface being stepped inwards towards the middle of the second tool support ring 3 providing a gap between the contact area on a ski base edge 12 and the second tool support ring 3 through which edge filings and debris may fall between second tool support ring 3 and ski base 11 when sharpening disc 4 is in contact with the side edge 19, or side wall 20 and the apparatus is moved along an edge portion of the ski while in contact with a surface thereof.

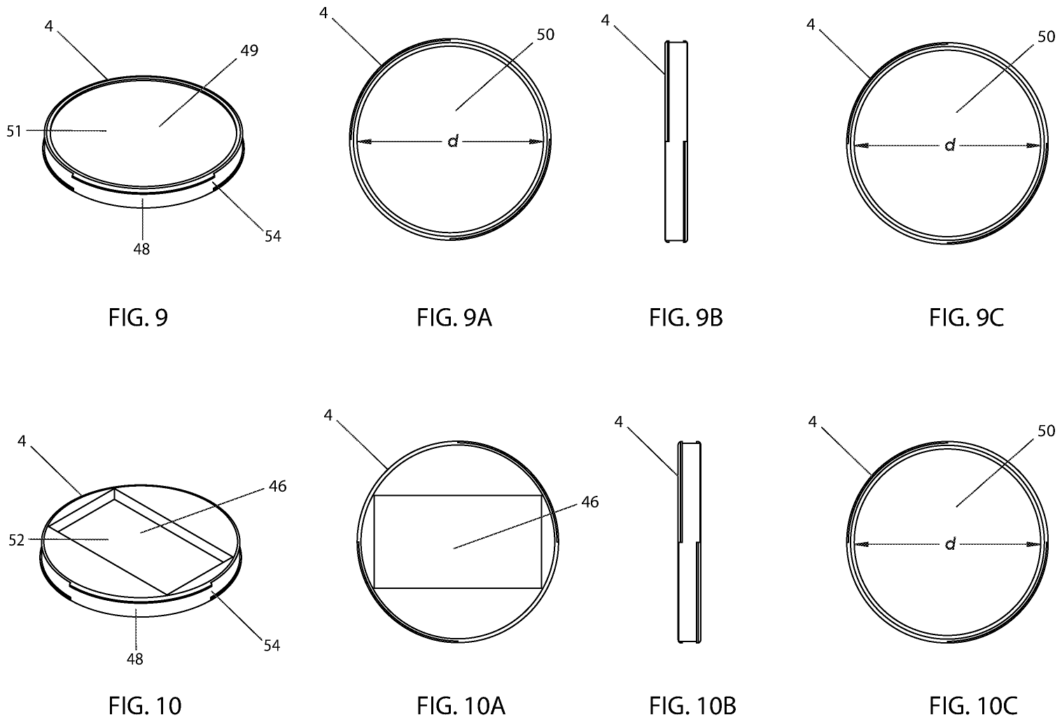

For another embodiment, FIGS. 9, 9A, 9B, 9C, 10, 10A, 10B and 10C illustrate sharpening disc 4 that may be inserted within the first tool support ring 2 to facilitate attempting to maximize having as much as possible of diameter “d” of disc 4 contacting the surface of ski base edge 12, side edge 19, or side wall 20 thereby assisting in maximizing edge cutting and polishing efficiency of disc 4. As such, first tool support surface 7, second tool support surface 8, third tool support surface 9 and forth tool support surface 10 of first tool support ring 2 and fifth tool support surface 13, sixth tool support surface 14, seventh tool support surface 15 and eighth tool support surface 16 of second tool support ring 3 provide alignment feature(s) relative to disc 4 and indicating a contact area for a surface of sharpening disc 4 when contacting either the base or side portion of a ski as the apparatus is moved lengthwise along a ski edge while in contact with a surface thereof.

As shown in FIGS. 4, 5, 6, 11, 11A, 13, 13A, 14, 14A, 15, 15A, 16 and 16A for one embodiment, guide 1 comprises a first tool support ring 2 having an outer surface 5, an inner surface 6 and multiple disc support surfaces 7, 8, 9 and 10 each connecting outer surface 5 to inner surface 6, each disc support surface providing a surface to orient sharpening disc 4 at a set elevation and angle relative to a ski base edge 11. Here, position indexing tabs 37 are integrally formed along the circumference of ring 2 at approximately each end of a diameter of the ring and include a top surface 38, bottom surface 39 and side surfaces 40 and 41, each side surface providing an alignment feature relative to disc 4 and indicating a contact area when contacting the side of a ski to facilitate attempting to maximize having as much as possible of diameter “d” of disc 4 contacting the surface of ski base edge 11, thereby assisting in maximizing edge cutting and polishing efficiency of disc 4 when the apparatus is held by the hand of a technician and moved lengthwise along a ski edge while in contact with a surface thereof.

As best shown in FIGS. 8 and 12A and according to one embodiment, second tool support ring 3 may comprise at least one open area 42 in approximately its middle section where edge filings may fall to prevent the filings from becoming lodged between a second tool support ring support surface and the ski base when apparatus is moved lengthwise along an edge portion of the ski while in contact with a surface thereof.

As shown in FIGS. 2, 10, 10A, 12 and 12A in an embodiment, a set screw 43 (or other similar fastener) may be positioned with its longitudinal plane approximately perpendicular to the longitudinal plane of disc 4 and a file 44 and turned through at least one aperture 45 in second tool support ring 3 in order to clamp and hold file 44 against disc 4 and within file indent 46.

As best shown in FIGS. 5, 6, 7 and 8 and according to one embodiment, outer surfaces 5 and/or 17 of tool support rings 2 and/or 3 may further comprise printed markings 47 including text, numbers, degree (°) symbols, arrows or other directional indicators identifying the angle of each tool support surface 7, 8, 9, 10, 13, 14, 15 and 16. It will be appreciated means other than printing the markings for identifying the angle of each tool support surface may be used including, but not limited to, for example, identifying marks, numbers or other symbols molded, laser etched or milled into outer surfaces 5 and/or 17. Further details of the apparatus configuration and construction are described below.

According to one embodiment sharpening disc 4 is circular in shape, although it may be round, orbicular, elliptical, square, triangular, or any other polygonal shape. In an embodiment, sharpening disc 4 is comprised of backer 48, backer indent 49, and abrasive sheet 50 of varying grits on one or both sides of backer 48. One or both of sharpening disc 4 and/or backer 48 may have a circular cross-section. Backer 48 may be cylindrical in shape. Abrasive sheet 50 may be an abrasive diamond sheet, seeded gel ceramic grain sheet or a comparable abrasive sheet as known to a person of skill in the art. Abrasive sheet 50 has a thickness greater than the depth of indent 49 and may be applied and adhered to one or both indent surfaces 51 using an adhesive, or perhaps double-sided pressure sensitive tape, each diamond sheet 50 having an outside diameter slightly less than the diameter of indent 49. It will be appreciated that indent 49 provides an alignment and centering feature when applying and adhering diamond sheet 50 to indent surfaces 51, protects the edge of diamond sheet 50 from damage when in contact with the surface of ski side edge 19, and provides a mechanical support to reduce unwanted slipping of sheet 50 across indent surface 51, especially when disc 4 is positioned and pressed down upon the side edge or base edge portion of the ski and is in sliding contact with the surface thereof.

According to another embodiment, sharpening disc 4 is comprised of a backer 48 with file indent 46 and a file 44 placed against one or both sides of backer 48. File 44 has a thickness greater than the depth of file indent 46 and may be inserted into indent 46 so file 44 may be clamped against file indent surface 52 using set screw 43, the length and width of file 44 being slightly less than the length and width of indent 46. It will be appreciated that indent 46 provides an alignment and centering feature when placing file 44 at least partially within backer 48, and provides mechanical support to prevent unwanted slipping of file 44 across backer 48, especially when disc 4 is positioned and pressed down upon the side edge or base edge portion of the ski and is in sliding contact with the surface thereof.

In one embodiment, abrasive sheet 50 may be circular in shape. According to another embodiment, file 44 may be square or rectangular in shape. According to one embodiment, backer 48 may be dimensioned suitably to support abrasive sheet 50 and/or file 44 and may made from a sufficiently sturdy thermoplastics material which may be reinforced with glass fibers to provide additional strength and rigidity. According to another embodiment backer 48 may be made from metal, wood, carbon fiber and/or other suitable materials.

According to an embodiment, disc 4 may be symmetric about its longitudinal axis with a first abrasive surface or file positioned to contact the contact surface of an edge, and may be detached, rotated approximately 180° (one hundred and eighty degrees) about its longitudinal axis and re-attached to the first tool support ring 2 to position a second abrasive surface or file to contact the contact surface of an edge in order to vary the file, abrasive grit, or to change from file to abrasive depending on the cutting /polishing tool required to efficiently sharpen and/or polish the edge. In this respect disc 4 may be easily and repeatedly properly positioned within first tool support ring 2 by a technician using guide 1 to perform an efficient, accurate, and consistent edge sharpening and beveling job.

It will be appreciated that the term “file” as used in this disclosure is a generic term for a (handheld) sharpening tool that files and as known by a person of skill in the art encompasses a variety of cutting/polishing tools for file 44, such as rough (panzer) files, smooth (mill) files, extra-coarse, coarse, fine, and extra fine diamond whetstones, deburring stones, diamond abrasives, etc. typically of various rectangular shapes and sizes able to be placed upon and held by a hand or clamped to guide 1 at any one of a plurality of desired angular positions in a plane transverse to the lengthwise direction when positioned at the side edge portion of the ski according to preference of the technician using guide 1. Thus, a desired portion of the file length may make contact with ski side edge 19 and/or the teeth on file 44 may be oriented at any desired angle relative to the lengthwise direction of movement 100. This assists the technician using guide 1 in producing a consistent file cut and efficient edge sharpening or beveling job regardless of the amount of shaping or side cut of the ski.

As shown in FIGS. 9, 9A, 9B, 9C, 10, 10A, 10B, 10C, 11 and 11A, according to one embodiment there is shown sharpening disc 4 with a circumference corresponding to, and that may be aligned and inserted within an inner surface 6 of first tool support ring 2. As best shown in FIG. 11A, first tool support ring 2 is matable with one or more discs 4 via a set of mating features provided on ring 2 and disc 4 that are being fit together. The mating features may interact with each other to provide a positive interlocking attachment between the ring 2 and disc 4.

It will be appreciated that for an embodiment, an aspect may be provided that facilitates mating of two components together through a variety of first and second physically and dimensionally complementary features of the two components. For example, mating features can be provided on the ring 2 and disc 4 to allow the ring 2 and disc 4 to be connected together. The mating feature has a first feature on one component and a second feature on another component. Using first tool support ring 2 as an example, the first feature may be any protrusion extending from an inner surface 6 of ring 2 and may be a male feature (as described below), nodule, bulge, extension, bump, wall, post, rail, hook, bar or any other feature that may protrude outwardly from inner surface 6 of ring 2. Using disc 4 as an example, the second feature may be any complementary feature extending in the surface of disc 4 and may be a female feature (as described below), depression, rail, hook, groove, slot, channel or any other feature that may extend inwardly to disc 4 to receive the first feature in whole or in part. For the purpose of convenience, and not limitation, for the mating features, where the term “male feature” or “first mating feature” is used herein, it will be understood that these terms capture any protrusion described for the male feature herein and may be provided in place of the described male feature unless otherwise noted. Also, where the term “female feature” or “second mating feature” is used herein, it will be understood that these terms capture any depression described for the female feature herein and may be provided in place of the described female feature unless otherwise noted.

According to an embodiment, FIGS. 5, 7, 9, 10, 11 and 11A show tool support ring 2 and disc 4 that may be joined to each other by exemplary mating feature(s). For the embodiment, the mating features are features 53 and 54, which are provided on the tool support ring 2 and disc 4 respectively. For an embodiment, a male feature 53 protrudes from the inner surface 6 of tool support ring 2 and is shaped and dimensioned to mate with corresponding female feature 54 having a complementary depression in sharpening disc 4 to receive male feature 53 in a friction fit manner. In an embodiment, when inner surface 6 of tool support ring 2 and outer diameter of sharpening disc 4 are circular, male feature 53 and corresponding female feature 54 may also provide a bearing surface between tool support ring 2 and sharpening disc 4 allowing disc 4 to be infinitely rotated around its vertical axis within ring 2 by the hand as necessary to expose unused abrasive surface, or to align the teeth of a file, along the contact area of an edge in order to efficiently sharpen (and polish) the side edge or base edge, the vertical axis of the sharpening disc 2 being approximately 90° (ninety degrees) perpendicular to the longitudinal plane of sharpening disc 2. In other embodiments, the male and female feature locations may be reversed.

In other embodiments additional or less features may be provided than those shown in FIG. 11A. In an embodiment the male features may be identically shaped and sized, but they can be different shapes and sizes. Also, the female features may be identically shaped and sized, but they too can be different shapes and sizes. The male/female features 53 and 54 may or may not have complementary female /male features 54 and 53 located on an opposite side of ring 2 or disc 4. Different exemplary shapes for male feature 53 and female feature 54 include shapes having a perimeter of any of a triangle, square, pentagonal, hexagonal, star, etc. Tool support ring 2 and sharpening disc 4 may be joined to each other at a variety of angles by mating male feature 53 and female feature 54. Male feature 53 and corresponding female feature 54 joining support ring 2 and disc 4 may be reversed or interchanged.

In an embodiment, representative dimensions for sharpening disc 4, when it is circular, provide a diameter of approximately 47 mm for backer 48, a diameter of approximately 45 mm for abrasive sheet 50, and a thickness of approximately 4.1 mm for backer 48. As such, a representative range of dimensions sharpening disc 4 has a diameter of between approximately 25.4 mm and 50.8 mm (namely, approximately between 1″ and 2″) and with a thickness between approximately 1.9 mm and 6.35 mm (namely, between approximately 0.075″ and 0.25″). It will be appreciated that these representative dimensions are non-limiting and that that other dimensions and/or shapes for disc 4 may be provided in other embodiments that effect a comparable function and effect of such discs.

As noted earlier, rings 2, 3 are sharpening disc support rings where each disc support surface 7, 8, 9, 10, 13, 14, 15 and 16 provides a support surface for sharpening disc 4. According to one embodiment, each tool support ring 2, 3 may be connected together as integral parts. According to one embodiment, tool support rings 2, 3 may be molded together to form a single unified part as a “one piece” construction. According to one embodiment, each ring 2, 3 and sharpening disc 4 may be made from a rigid/sturdy thermoplastics material which may have reinforced with glass fibers. According to one embodiment, each ring 2, 3 and sharpening disc 4 may be made from metal, wood, carbon fiber, or any other suitable materials or combination thereof that provides sufficient rigidity and strength, as needed.

It will be appreciated that features describing aspects of embodiments as being “vertical”, “parallel”, “aligned” or in other terms relating to position or orientation have a range of acceptable values or positions that, if provided, still provide a functional embodiment. For example, a component described as having “vertical” or “parallel” element(s) will encompass elements that are substantially vertical or parallel. As a further example, if two components are described as being “parallel” in orientation, other embodiments will tolerate the two components being aligned in a nearly parallel fashion (where the description may use the term “generally parallel”). Similarly, if a component is described as being “aligned”, other embodiments will tolerate a component being nearly aligned. It will be plainly obvious to a person of skill in the art as to what range of values would be acceptable.

In this disclosure, where a threshold or dimension is provided as an approximate value (for example, when a dimension or threshold is qualified with the term “approximately”), a range of values will be understood to be valid for that value. For example, for a dimension stated as an approximate value, a range of about 25% larger and 25% smaller than the stated value may be used. Thresholds, values, measurements, and dimensions of features are illustrative of embodiments and are not limiting unless noted. Further, a “sufficient” designation (e.g. a sufficient size) may mean having dimensions or values that provide a minimum amount of material or size to achieve a stated function of the related parameter.

In this disclosure, where the conjunction “and/or” is used to end a list of elements, it will be understood that its use indicates an “inclusive or” of the listed elements. As such, the phrase “X and/or Y” means “(X or Y) or (both X and Y)”.

Although this disclosure describes embodiments where the apparatus are used to assist sharpening an edge of a ski or snowboard, it will be appreciated that other embodiments may be provided for sharpening edges of other sports equipment or devices where a sharpening tool requires support against a plane of such devices.

Although the disclosure has been described with reference to certain specific embodiments, various modifications thereof will be apparent to those skilled in the art without departing from the scope of the disclosure as outlined in the claims appended hereto.

What is claimed is:

1. An apparatus for supporting a sharpening tool when tuning an edge of a ski or snowboard, the apparatus comprising:
a first tool support ring having
an outer surface,
an inner surface
and a first tool support surface connecting the outer surface to the inner surface, the first tool support surface providing a surface for placing the sharpening tool when tuning the edge; and
a sharpening disc detachably matable to the inner surface of the first tool support ring.

2. The apparatus as claimed in claim 1, wherein:
the first tool ring further comprises a second tool support surface connecting the outer surface to the inner surface in a space relationship to the first tool support surface, the second tool support surface providing a second surface for placing the sharpening tool when sharpening the edge.

3. The apparatus as claimed in claim 1, wherein:
the first tool ring further comprises a third tool support surface connecting the outer surface to the inner surface in a space relationship to the first tool support surface, the third tool support surface providing a third surface for placing the sharpening tool when sharpening the edge.

4. The apparatus as claimed in claim 1, wherein:
the first tool ring further comprises a fourth tool support surface connecting the outer surface to the inner surface in a space relationship to the third tool support surface, the fourth tool support surface providing a fourth surface for placing the sharpening tool when sharpening the edge.

5. The apparatus as claimed in claim 2, wherein the first and second tool support surfaces are asymmetric to each other about a longitudinal axis of the first tool support ring.

6. The apparatus as claimed in claim 2, wherein one of the first and second tool support surfaces tapers towards the opposing tool support surface of the first tool support ring in a spaced relationship.

7. The apparatus as claimed in claim 2, wherein the first and second tool support surfaces taper towards each other from the outer surface to the inner surface about a longitudinal axis of the first tool support ring.

8. The apparatus as claimed in claim 4, wherein the third and fourth tool support surfaces are asymmetric to each other about a longitudinal axis of the first tool support ring.

9. The apparatus as claimed in claim 4, wherein one of the third and fourth tool support surfaces tapers towards the opposing tool support surface of the first tool support ring in a spaced relationship.

10. The apparatus as claimed in claim 4, wherein the third and fourth tool support surfaces taper towards each other from the outer surface to the inner surface about a longitudinal axis of the first tool support ring.

11. The apparatus as claimed in claim 1, further comprising:
a second tool support ring having
a second tool outer surface,
a second tool inner surface, and
a second tool first support surface connecting the second tool outer surface to the second tool inner surface, the second tool support surface providing a fifth surface for placing the sharpening tool, the second tool support ring connected to the first tool support ring such that the centers of both rings share a common point and their planes are approximately perpendicular to each other.

12. The apparatus as claimed in claim 1, wherein:
the second tool ring further comprises a second tool support surface connecting the outer surface to the inner surface in a space relationship to the first tool support surface, the second tool support surface providing a sixth surface for placing the sharpening tool when sharpening the edge.

13. The apparatus as claimed in claim 1, wherein:
the second tool ring further comprises a third tool support surface connecting the outer surface to the inner surface in a space relationship to the first tool support surface, the third tool support surface providing a seventh surface for placing the sharpening tool when sharpening the edge.

14. The apparatus as claimed in claim 1, wherein:
the second tool ring further comprises a fourth tool support surface connecting the outer surface to the inner surface in a space relationship to the third tool support surface, the fourth tool support surface providing an eighth surface for placing the sharpening tool when sharpening the edge.

15. The apparatus as claimed in claim 12, wherein the first and second tool support surfaces are asymmetric to each other about a longitudinal axis of the second tool support ring.

16. The apparatus as claimed in claim 12, wherein one of the first and second tool support surfaces tapers towards the opposing tool support surface of the second tool support ring in a spaced relationship.

17. The apparatus as claimed in claim 12, wherein the first and second tool support surfaces taper towards each other from the outer surface to the inner surface about a longitudinal axis of the second tool support ring.

18. The apparatus as claimed in claim 14, wherein the third and fourth tool support surfaces are asymmetric to each other about a longitudinal axis of the second tool support ring.

19. The apparatus as claimed in claim 14, wherein one of the third and fourth tool support surfaces tapers towards the opposing tool support surface of the second tool support ring in a spaced relationship.

20. The apparatus as claimed in claim 14, wherein the third and fourth tool support surfaces taper towards each other from the outer surface to the inner surface about a longitudinal axis of the second tool support ring.

21. The apparatus as claimed in claim 1, wherein the inner surface of the first tool support ring is circular and shaped to mate with and retain an outer circular surface of the sharpening disc providing a bearing surface between ring and disc and allowing the disc to be infinitely rotatable about a vertical axis of the disc within the ring.

22. The apparatus as claimed in claim 3, further comprising:
A sharpening disc having a first abrasive surface; and
first position indexing tabs protruding from between first and third tool support surfaces, the indexing tabs providing an alignment feature for a shape of the sharpening disc marking a contact area for the first abrasive surface on an edge of a ski or snowboard.

23. The apparatus as claimed in claim 4, further comprising:
a sharpening disc having a second abrasive surface; and
second position indexing tabs protruding from between second and fourth tool support surfaces, the indexing tabs providing an alignment feature for a shape of the sharpening disc marking a contact area for the second abrasive surface on an edge of a ski or snowboard.

24. The apparatus as claimed in claim 22, wherein:
The shape of the sharpening disc is circular; and
the position indexing tabs indicate that approximately half of the abrasive disc will contact the contact area.
